(19) United States
(12) Patent Application Publication
(10) Pub. No.: US 2016/0319772 A1
(43) Pub. Date: Nov. 3, 2016

(54) METHOD FOR CONTROLLING A PROPULSION SYSTEM

(71) Applicant: SNECMA, Paris (FR)

(72) Inventor: Gaëlle LE BOUAR, Saint-Marcel (FR)

(73) Assignee: SNECMA, Paris (FR)

(21) Appl. No.: 15/107,700

(22) PCT Filed: Dec. 30, 2014
(86) PCT No.: PCT/FR2014/053574

§ 371 Date: Jun. 23, 2016

(30) Foreign Application Priority Data
Jan. 10, 2014 (FR) 1450167

(51) Int. Cl. F02K 9/58; F02K 9/48

(52) U.S. Cl. CPC F02K 9/58; F02K 9/48; F05D 2270/3061; F05D 2270/304

(57) ABSTRACT

The invention relates to the field of propulsion assemblies, and in particular to rocket engines of the “expander” type, wherein at least one propulsion chamber (40) is fed with at least a first propellant by a first pump (33) coupled to a first turbine (34) that is driven by partial expansion of said first propellant upstream from said propulsion chamber (40) after passing, downstream from the first pump (33), through a heat exchanger (23) heated by said propulsion chamber (40). A method of the invention for controlling such a propulsion assembly (10) comprises the steps of determining whether there exists a risk of instability for the propulsion assembly (10), and in response to determining that said risk of instability exists, using a branch connection (28) situated between the first turbine (34) and the propulsion chamber (40) to shed a portion of said first propellant.

### BACKGROUND OF THE INVENTION

The present invention relates to a method of controlling a propulsion assembly, and more particularly a rocket engine of the so-called “expander” cycle type, in which partial expansion of at least one propellant, after being heated by combustion heat and prior to being injected into a propulsion chamber, serves to drive a turbine coupled to a propellant pump for causing the propellant to flow towards the propulsion chamber.

In the description below, the terms “upstream” and “downstream” are defined relative to the normal flow direction of at least one propellant while the propulsion assembly is in operation.

A propulsion assembly is a dynamic system with feedback that can lead to phenomena of instability. Thus, by way of example, too low a mass flow rate of propellant through a pump can lead to instability that endangers the operation and even the physical integrity of the propulsion assembly and of its payload, if any. This drawback can in particular prevent such a propulsion assembly from operating in a low thrust mode.

### OBJECT AND SUMMARY OF THE INVENTION

The present invention seeks to remedy those drawbacks. More specifically, the present description seeks to propose a method of controlling a propulsion assembly, and more particularly a propulsion assembly that enables a situation of instability to be avoided. In this propulsion assembly, at least one propulsion chamber is fed with at least a first propellant by a first pump coupled to a first turbine that is driven by partial expansion of said first propellant upstream from said propulsion chamber after passing, downstream from the first pump, through a heat exchanger heated by said propulsion chamber.

In at least one implementation, this object is achieved by the fact that the control method comprises at least the steps of determining whether there exists a risk of instability for the propulsion assembly, and in response to determining that said risk of instability exists, using a branch connection situated between the first turbine and the propulsion chamber to shed a portion of said first propellant.

By means of these provisions, it is possible to avoid expected instability of the propulsion assembly by conditionally enabling the flow rate of propellant through the first pump and the first turbine to be increased without increasing the extra pressure delivered by the first pump.

Typically, but not necessarily, such propulsion assemblies have two propellants, i.e. propulsion is provided by a chemical reaction between the first propellant and a second propellant in the propulsion chamber. By way of example, the propulsion chamber may be fed with the second propellant by a second pump, even though alternative or additional feed means can also be envisaged by the person in the art, such as for example pressurizing a tank of the second propellant. In order to drive the second pump, it may be coupled to a second turbine, e.g. situated downstream from the first turbine, and it too may be driven by partial expansion of said first propellant after it has been heated by heat coming from said propulsion chamber, this partial expansion taking place downstream from the first pump and prior to the first propellant being injected into said propulsion chamber. Nevertheless, it is also possible for the person skilled in the art to envisage alternative or additional means for driving the second pump, such as for example electrical drive or coupling to the first turbine.

The risk of instability may be determined in particular as a function of a pump flow rate coefficient of said first pump that is calculated by dividing volume flow rate of said first propellant as driven by the first pump by angular velocity of the first pump. In particular, it may be determined that there is a risk of instability if said pump flow rate coefficient of the first pump is less than a predetermined threshold, which would indicate proximity to unstable conditions. Several alternative methods for determining said volume flow rate may be applied simultaneously, in order to obtain redundancy in this estimate.

Nevertheless, and alternatively, said risk of instability may be determined in application of an instability criterion calculated as a function of at least one physical parameter.

The invention also provides a computer memory medium including a set of instructions for performing this control method by means of a control unit connected to at least said branch connection valve. The term “computer memory medium” is used to cover any data medium capable of being read by a computer device, and in particular an electronic computer device. Thus, computer memory media include magnetic media, such as magnetic tapes and disks, optical media, such as optical disks, and electronic media, such as volatile or non-volatile electronic memories.

The invention also provides propulsion assemblies. In particular, in at least one embodiment, such a propulsion assembly may comprise at least a propulsion chamber, a first pump for feeding said propulsion chamber with a first propellant, a heat exchanger connected upstream to the first pump and suitable for being heated by said propulsion chamber, a first turbine coupled to the first pump and suitable for being driven by partial expansion of said first propellant, and connected upstream to the heat exchanger and downstream to the propulsion chamber, a branch connection situated between the first turbine and the propulsion chamber, and a control unit connected to at least one branch connection valve situated on the branch connection, and configured to determine whether there is a risk of instability for the propulsion assembly, and to cause said branch connection valve to be opened to shed a portion of the flow of said second propellant via said branch connection in response to determining that said risk of instability exists.

### BRIEF DESCRIPTION OF THE DRAWINGS

The invention can be well understood and its advantages appear better on reading the following detailed description of two embodiments given as non-limiting examples. The description refers to the accompanying drawings, in which:

FIG. 1 is a diagram showing a multistage space launcher;

FIG. 2 is a diagram showing a propulsion assembly in an embodiment of the invention;

FIG. 3 is a curve showing the relationship between a pump flow rate coefficient and a reduced total pump pressure rise coefficient in a first pump of said propulsion assembly;

FIGS. 4A and 4B show respectively how the pump outlet pressure and the flow rate delivered by said first pump vary in a situation of instability; and

FIGS. 5A and 5B show respectively how the pump outlet pressure and the flow rate delivered by said first pump vary in an analogous situation, in which instability is nevertheless avoided by the control method in an implementation.

### DETAILED DESCRIPTION OF THE INVENTION

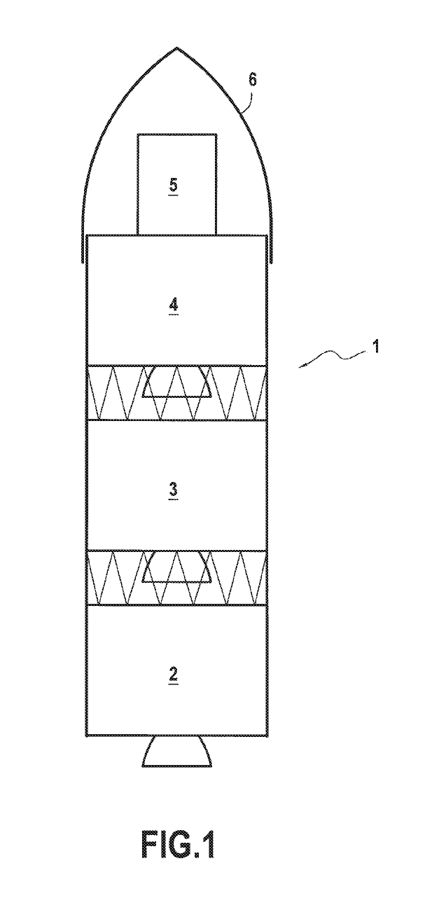

A multistage space launcher 1 is shown diagrammatically in FIG. 1. The launcher 1 shown comprises three successive stages 2, 3 and 4, together with a payload 5, e.g. such as a satellite, under a nose cone 6 fastened in releasable manner on the last of the three stages. Each of the three stages 2, 3, 4 comprises a rocket engine type propulsion assembly thus enabling the payload 5 to be launched and put into orbit. For this purpose, the propulsion assemblies of the three stages 2, 3, and 4 are fired in succession, with each spent stage being separated before firing the propulsion assembly of the following stage.

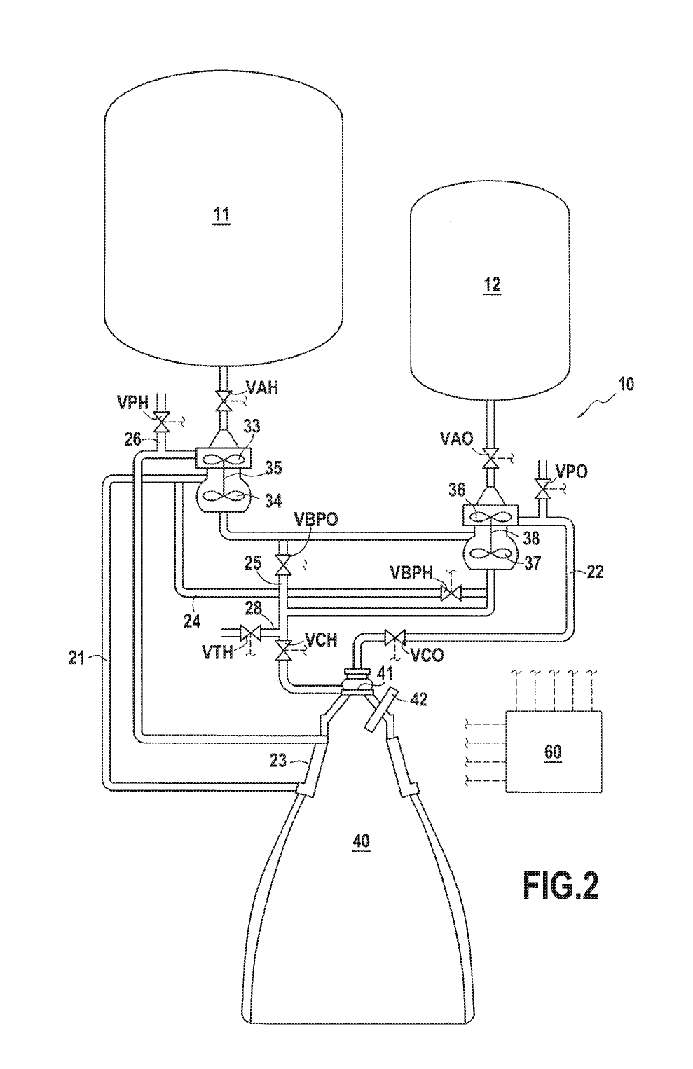

FIG. 2 shows a propulsion assembly 10 in a first embodiment. The propulsion assembly 10 could be fitted to any of the stages of such a space launcher, or even to a space vehicle launched as payload by such a space launcher. The propulsion assembly 10 shown is a “expander” type cycle rocket engine, i.e. a rocket engine having liquid propellants and turbopump feed, in which the turbopump is actuated by expanding one of the propellants after it has been heated and vaporized in a regenerative heat exchanger that is heated by the propulsion chamber.

The propulsion assembly 10 shown comprises a first tank 11 suitable for containing a first propellant, a second tank 12 suitable for containing a second propellant, a first feed circuit 21, a second feed circuit 22, a first turbopump TPH, a second turbopump TPO, and a propulsion chamber 40. The first turbopump TPH comprises a pump 33 and a turbine 34 that are coupled together in rotation by a common rotary shaft 35. The second turbopump TPO also comprises a pump 36 and a turbine 37 that are coupled together in rotation by a common rotary shaft 38. Typically, the first and second propellants are cryogenic propellants, and more specifically respective liquid hydrogen and liquid oxygen.

The first feed circuit 21, which is connected upstream to the first tank 11, passes in succession through the pump 33 of the first turbopump TPH, a heat exchanger 23 incorporated in an outer wall of the propulsion chamber 40, the turbine 34 of the first turbopump TPH, and the turbine 37 of the second turbopump TPO, prior to leading to an injector device 41 for injecting into the propulsion chamber 40. This first feed circuit 21 also has a first bypass line 24 bypassing the turbines 34 and 37, a second bypass line 25 bypassing the turbine 37, a first branch connection 26 situated between the pump 33 and the heat exchanger 22 and connected to a purge line, and a second branch connection 28 situated between the turbine 37 and the injector device 41, and suitable for being connected to an autogenous pressurization circuit (not shown) for pressurizing the first tank 11.

In order to regulate the propellant flow rate through the first feed circuit 21, the circuit also includes a feed valve VAH directly downstream from the first tank 11, a first bypass valve VBPH in the first bypass line 23, a second bypass valve VBPO in the second bypass line 24, a valve VCH directly upstream from the injector device 41, a purge valve VPH situated on the first branch connection 26, and a branch valve VTH situated on the second branch connection 28. For control purposes, all of these valves are connected to a control unit 60, which may in particular be a programmable electronic unit, thus comprising at least one electronic processor connected to a data medium containing a set of instructions for enabling the control unit 60 to perform a control method.

The second feed circuit 22, which is connected upstream to the second tank 12, passes through the pump 36 of the second turbopump TPO prior to opening out likewise into the injector device 41 for injection into the propulsion chamber 40. The second feed circuit 22 has a branch connection connected to a purge line. In order to contribute to regulating the propellant flow rate through the second feed circuit 22, this circuit also includes a feed valve VAO directly downstream from the second tank 12, another valve VCO directly upstream from the injector device 41, and a purge valve VPO situated on the branch connection. These other valves VAO, VCO, and VPO are also connected to the control unit 60, as indeed are an ignition device 42 in the propulsion chamber 40, a temperature sensor T for sensing the temperature of the fluid passing through the pump 33, a sensor for sensing the angular speed co of the pump 33, respective sensors for sensing the inlet and outlet pressures of the pump 33, and possibly a flow meter for measuring the mass flow rate Q of the fluid passing through the pump 33.

In order to start this propulsion assembly, the feed circuits 21 and 22 are initially cooled down. For this purpose, with the purge valves VPH, VPO and also the bypass valves VBPH and VBPO open, the feed valves VAH and VAO are opened gradually while keeping the valves VHC and VCO that are directly upstream from the propulsion chamber 40 closed. The propellants thus penetrate into the feed circuits 21 and 22, thereby preventing any sudden thermal shocks, and purging any other substances that might be in the circuits 21 and 22 prior to starting. Thereafter, the valves VCH and VCO are opened, and after a sufficient quantity of propellant has reached the propulsion chamber 40 through the injector device 41, the ignition device 42 is activated so as to ignite the mixture of propellants in the propulsion chamber 40. After this ignition, the purge valves VPH and VPO are closed and the heat generated by combustion of the mixture of propellants in the propulsion chamber 40 begins to heat the first propellant as it passes through the heat exchanger 23. The bypass valves VBPH and VBPO are then closed progressively in order to direct this hot propellant through the turbines 34 and 37 so as to drive the turbopumps TPH and TPO by partial expansion of this first propellant through the turbines 34 and 37. The degree to which the bypass valves VBPH and VBPO are open can then be used to regulate the rate of operation of the propulsion assembly 10, even though other means, such as for example brake devices (not shown) for the turbopumps TPH and TPO, or opening the purge valves VPH and VPO, might also be used for this purpose.

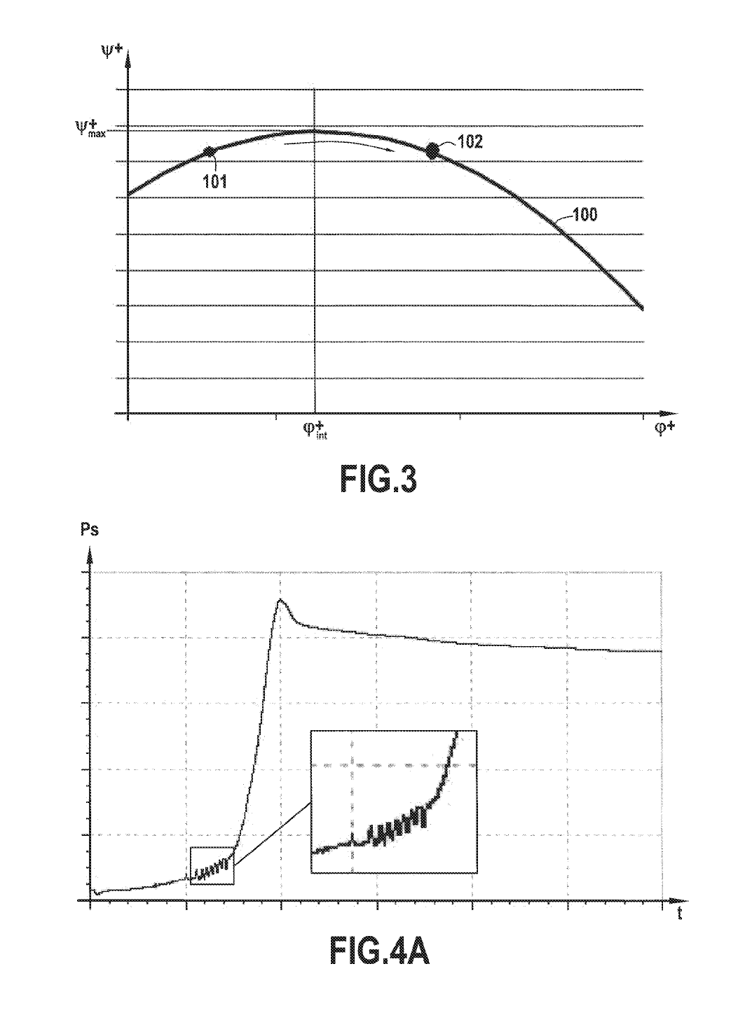

Nevertheless, a drawback of regulating operating rate in this way is that in certain regions of operation, in particular at restricted thrust levels, when the flow rate of propellant delivered by the first pump is comparatively low relative to the pressure rise delivered by the first pump, the operation of the turbopump can become unstable. FIG. 3 plots a characteristic curve 100 for the turbopump TPH, in which the vertical axis corresponds to the values of a reduced total pressure rise coefficient ψ⁺ of the pump 33, and the horizontal axis corresponds to values of a flow rate coefficient φ+ of the pump 33.

The coefficient ψ⁺ corresponds to the difference Δp between the outlet pressure pₛ and the inlet pressure pₑ of the pump 33, divided by the density ρ of the first propellant passing through the pump 33 and by the square of the annular velocity co of the pump 33, in application of the formula:

$${Ψ}^{+} = \frac{{p}_{s} - {p}_{e}}{ρ \cdot {ω}^{2}}$$

For its part, the coefficient φ⁺ corresponds to the volume flow rate delivered by the same pump 33, i.e. its mass flow rate Q divided by the above-mentioned density ρ and divided by said angular velocity ω, in application of the formula:

$${Ψ}^{+} = \frac{Q}{ρ \cdot ω}$$

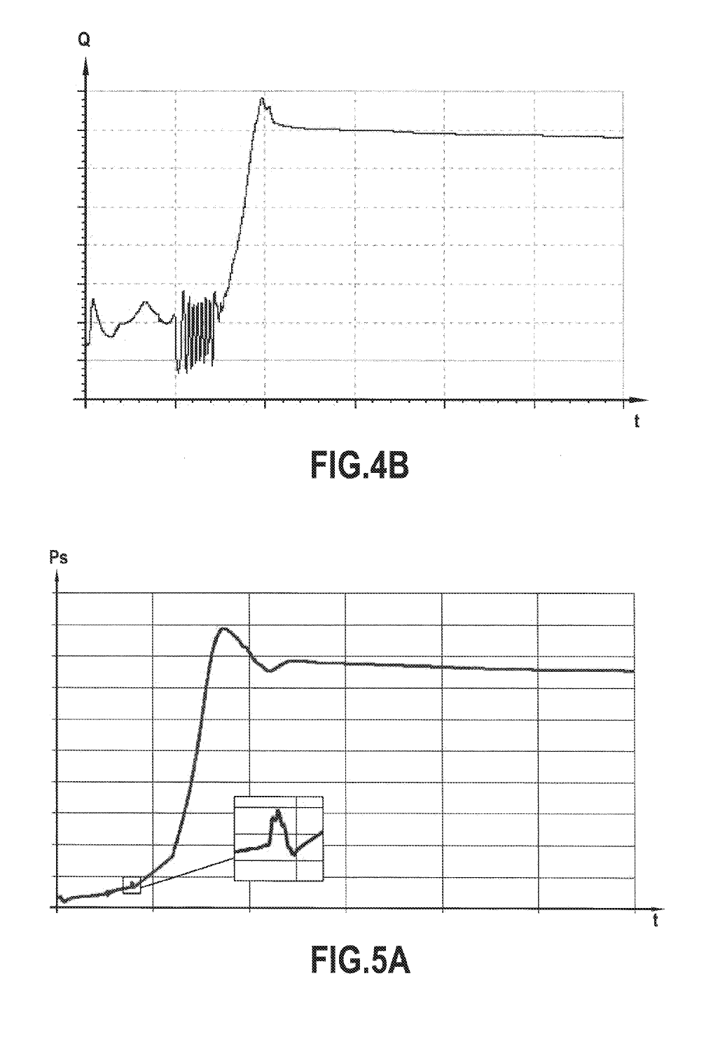

As can be seen in FIG. 3, the reduce pressure rise coefficient ψ⁺ initially increases with increasing flow rate coefficient φ⁺, reaches a maximum value ψ⁺ₘₐₓ corresponding to a critical value φ⁺_{crit} for the flow rate coefficient φ⁺, and then decreases with the flow rate coefficient φ⁺ increasing beyond the critical value w Consequently, when the flow rate coefficient φ⁺ is greater than φ⁺_{crit}, the turbopump TPH operates under naturally stable conditions, whereas when the flow rate coefficient φ⁺ is less than the critical value φ⁺_{crit} the response of the feed circuit 21 may be such that the turbopump TPH enters into unstable conditions that are manifested by perceptible oscillations in the outlet pressure pₛ and in the mass flow rate Q delivered by the pump 33, as shown respectively in FIGS. 4A and 4B.

As can be seen in FIG. 3, it is possible to go from a point 101 in the zone of instability to a point 102 in the zone of stability having the same reduced pressure rise coefficient ψ⁺, but with an increase in the flow rate coefficient φ⁺. Consequently, partial shedding downstream from the turbine 34, by increasing the flow rate Q, can make it possible to avoid a situation of instability. Such shedding can be obtained in particular by opening the branch connection valve VTH, enabling a portion of the total flow rate of the first propellant pumped by the turbopump TPH to escape, in response to determining that there is a risk of instability.

In a first embodiment, the control unit 60 determines that there is a risk of instability if the flow rate coefficient φ⁺ of the pump 33 is less than a predetermined threshold φ⁺ₗᵢₘ that is equal to or greater than the critical value φ⁺_{crit}. More specifically, said predetermined threshold φ⁺_{crit} may be equal to the sum of the critical value plus a predetermined safety margin for taking account of fabrication tolerances and other hardware dispersions.

The flow rate coefficient φ⁺ may in particular be calculated by the control unit 60 as a function of parameters picked up by the sensors, including the flow meter. The mass flow rate Q or the volume flow rate Q/ρ delivered by the pump 33 can be measured directly by the flow meter, or rather, in particular if there is no such flow meter, indirectly via the pressure, temperature, and angular velocity values pₑ, pₛ, T, and ω picked up using the corresponding sensors, and via a characteristic function for the pump 33 associating these critical parameters of the pump 33 in operation with mass or volume flow rate that it delivers.

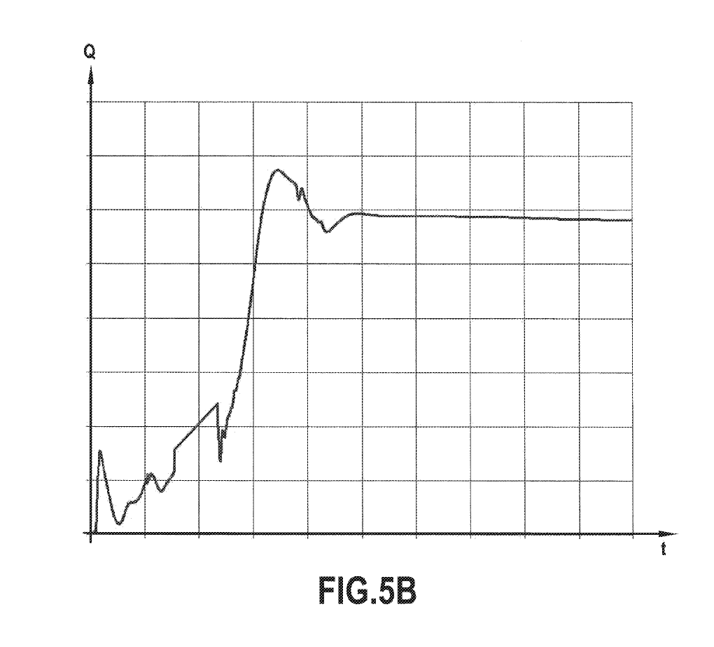

In response to determining that there is a risk of instability, the control unit 60 issues a command to open the branch connection valve VTH, thereby increasing the mass and volume flow rate of the pump 33, and its flow rate coefficient φ⁺, thus avoiding instability of the turbopump TPH. FIGS. 5A and 5B show how the outlet pressure pₛ and the mass flow rate Q vary under circumstances analogous to those of FIGS. 4A and 4B but when the method is performed, with the branch connection valve VTH being opened in response to it being determined there is a risk of instability. It can be seen how this avoids perceptible oscillations in these two parameters.

Although in this first implementation the criterion serving to determine that there is a risk of instability is the flow rate coefficient φ⁺, other criteria could be used as alternatives or in addition thereto. Thus, in a second implementation, the criterion may be a probability of instability depending on a model for predicting instability of the turbopump TPH. This instability prediction model may be developed on the basis of a set of experiments incorporating a plurality of different starting sequences. On the basis of this set of experiments, at least one physical parameter will be identified that is associated with there being a risk of instability, and the probability of instability can be calculated as a function of this at least one physical parameter. By way of example, it is thus possible that the risk of turbopump instability can be expressed as a function f(ω, Q, pₛ) involving the angular velocity ω, the mass flow rate Q, and the temperature T as measured, directly or indirectly, using the sensors, including the flow meter. Since a risk of instability triggers downstream shedding of the turbines 34 and 37, it is then possible to determine whether the probability as calculated exceeds an acceptable predetermined probability threshold fₗᵢₘᵢₜ.

Although the present invention is described with reference to a specific implementation, it is clear that various modifications and changes may be made to the implementations without going beyond the general ambit of the invention as defined by the claims. Thus, although in the implementation shown the propulsion assembly has only one propulsion chamber, in alternative implementations the propulsion assembly could have a plurality of propulsion chambers, e.g. each being fed by its own pair of turbopumps. In addition, although in the implementation shown the propulsion assembly has one turbopump per propellant, it is also possible in other implementations to use a common turbine for driving both pumps, or to use some other method for feeding the second propellant. In addition, individual characteristics of the various implementations mentioned may be combined in additional implementations. Consequently, the description and the drawings should be considered in a sense that is illustrative rather than restrictive.

1. A control method for controlling a propulsion assembly in which at least one propulsion chamber is fed with at least a first propellant by a first pump coupled to a first turbine that is driven by partial expansion of said first propellant upstream from said propulsion chamber after passing, downstream from the first pump, through a heat exchanger heated by said propulsion chamber, the control method comprising the steps of:
determining whether there exists a risk of instability for the propulsion assembly; and
in response to determining that said risk of instability exists, using a branch connection situated between the first turbine and the propulsion chamber to shed a portion of said first propellant.

2. The control method according to claim 1, wherein said propulsion chamber is fed with a second propellant by a second pump.

3. The control method according to claim 2, wherein said second pump is coupled to a second turbine that is also actuated by partial expansion of said first propellant after it has passed through the heat exchanger.

4. The control method according to claim 3, wherein said second turbine is situated downstream from the first turbine.

5. The control method according to claim 1, wherein said risk of instability is determined as a function of a pump flow rate coefficient (φ⁺) of said first pump, calculated by dividing a volume flow rate of said first propellant driven by the first pump by an angular velocity of the first pump.

6. The control method according to claim 5, wherein the volume flow rate of the first propellant driven by the first pump is estimated indirectly on the basis of physical parameters other than said volume flow rate of the first propellant.

7. The control method according to claim 5, wherein it is determined there is a risk of instability if said pump flow rate coefficient (φ⁺) of the first pump is less than a predetermined threshold.

8. The control method according to claim 1, wherein said risk of instability is determined in application of an instability criterion calculated as a function of at least one physical parameter.

9. A propulsion assembly comprising at least:
a propulsion chamber;
a first pump for feeding said propulsion chamber with a first propellant;
a heat exchanger connected upstream to the first pump and suitable for being heated by said propulsion chamber;
a first turbine coupled to the first pump and suitable for being driven by partial expansion of said first propellant, and connected upstream to the heat exchanger and downstream to the propulsion chamber;
a branch connection situated between the first turbine and the propulsion chamber; and
a control unit connected to at least one branch connection valve situated on said branch connection;
the propulsion assembly being characterized in that the control unit is configured to determine whether there is a risk of instability for the propulsion assembly, and to cause said branch connection valve to be opened to shed a portion of the flow of said first propellant via said branch connection in response to determining that said risk of instability exists.

10. A data medium including a set of instructions for performing a control method according to claim 1 by means of a control unit connected to at least one branch connection valve (VTH) situated on said branch connection.
